(19) United States
(12) Patent Application Publication
(10) Pub. No.: US 2005/0244641 A1
(43) Pub. Date: Nov. 3, 2005

(54) Coating and/or treating hydraulic fracturing proppants to improve wettability, proppant lubrication, and/or to reduce damage by fracturing fluids and reservoir fluids

(75) Inventor: Michael C. Vincent, Golden, CO (US)

Correspondence Address: HAYNES AND BOONE, LLP, 901 MAIN STREET, SUITE 3100, DALLAS, TX, 75202, US

(73) Assignee: CARBO Ceramics Inc., Irving, TX (US)

(21) Appl. No.: 11/103,777

(22) Filed: Apr. 12, 2005

Related U.S. Application Data
(60) Provisional application No. 60/561,486, filed on Apr. 12, 2004.

(51) Int. Cl. B32B 1/00; B32B 27/00

(52) U.S. Cl. 428/403; 428/405; 428/407

(57) ABSTRACT

Surface modified oil and gas well hydraulic fracturing proppants for improving wettability, altering chemical reactivity, altering surface topography, imparting lubricity or controlling relative permeability to flow of fluids of such proppants. The use and preparation of such coated proppants in hydraulic fracturing of subterranean formations is also described.

### CROSS-REFERENCE TO RELATED APPLICATIONS

This patent application is a non-provisional of U.S. Patent Application No. 60/561,486, filed on Apr. 12, 2004, entitled “Coating and/or Treating Hydraulic Fracturing Proppants to Improve Wettability, Proppant Lubrication, and/or to Reduce Damage by Fracturing Fluids and Reservoir Fluids,” which is incorporated by reference herein in its entirety.

### BACKGROUND OF THE INVENTION

The present invention relates to oil and gas well proppants and, more particularly, to processes for physically or chemically modifying the surface characteristics of hydraulic fracturing proppants.

Oil and natural gas are produced from wells having porous and permeable subterranean formations. The porosity of the formation permits the formation to store oil and gas, and the permeability of the formation permits the oil or gas fluid to move through the formation. Permeability of the formation is essential to permit oil and gas to flow to a location where it can be pumped from the well. Sometimes the permeability of the formation holding the gas or oil is insufficient for optimal recovery of oil and gas. In other cases, during operation of the well, the permeability of the formation drops to the extent that further recovery becomes uneconomical. In such cases, it is necessary to fracture the formation and prop the fracture in an open condition by means of a proppant material or propping agent. Such fracturing is usually accomplished by hydraulic pressure, and the proppant material or propping agent is a particulate material, such as sand, glass beads or ceramic particles, which are carried into the fracture by means of a fluid.

Spherical particles of uniform size are generally acknowledged to be the most effective proppants due to maximized permeability. For this reason, assuming other properties to be equal, spherical or essentially spherical proppants, such as rounded sand grains, metallic shot, glass beads and tabular alumina, are preferred.

Conductivity is a measure of how easily fluids can flow through proppant or sand and generally the higher the conductivity, the better. Current industry practices with existing proppants typically result in 50% or greater conductivity loss due to damage by fracturing fluids that are required to transport the proppant into the fracture.

It is known in the art to resin-coat proppants and to treat fractures and formations to reduce buildup of barium sulfate scale in the fracture and wellbore.

### DETAILED DESCRIPTION OF THE PREFERRED EMBODIMENT

The present process is one for modifying the surface properties of hydraulic fracturing proppants. Proppants are natural sands or ceramic granules used in the hydraulic fracturing of oil and gas wells. For instance, see U.S. Pat. Nos. 4,068,718, 4,427,068, 4,440,866 and 5,188,175, the entire disclosures of which are incorporated herein by reference. When pumped into well fractures at high pressure, the proppants “prop” open the fractures and create conduits through which oil and gas easily flow, thereby increasing well production.

Embodiments of the present invention relate to modifying the surface properties of natural sand, resin-coated sand and manufactured proppants used in oil and gas recovery to achieve one or more of the following desirable effects: alter the wettability, alter the chemical reactivity, alter the surface topography, impart lubricity, and control relative permeability to flow of fluids of such proppants. Sands, resin coated sands or manufactured proppants are treated, such as by coating, so as to provide a smoother surface to the particles/proppants, to modify their wettability or fluid affinity, to modify their chemical reactivity, or to reduce particle-to-particle friction properties.

These benefits can be achieved by a variety of techniques, including coating the proppants with a hydrophobic material such as silicon containing compounds, including silicone materials and siloxanes, polytetrafluoroethylene (commonly known as Teflon®), plant oils, such as linseed oil, soybean oil, corn oil, cottonseed oil, vegetable oil (widely commercially available such as Crisco®), and canola oil, and hydrocarbons such as kerosene, diesel, and crude oil, petroleum distillates such as hydrocarbon liquids comprising a mixture of C₇-C₁₂ aliphatic and alicyclic hydrocarbons and aromatic hydrocarbons (C₇-C₁₂), commonly known as Stoddard Solvent, aliphatic solvents, solvent naphtha (medium aliphatic and light aromatic), and paraffin, such as solvent dewaxed heavy paraffinic petroleum distillate. According to the present invention, the coating is applied to the proppant by one or more of a variety of techniques well known to those of ordinary skill in the art including chemically coating the proppant by means of spraying, dipping or soaking the proppant in a liquid solution of the hydrophobic material, application of a sheet of film such as copolymerized polyvinylidene chloride (commercially available as Saran Wrap®) to essentially “shrink-wrap” the proppant and encapsulate it in a chemically desirable coating, fusing material to the proppant in a manner similar to that utilized to fuse toner in a laser printer by placing heated proppant into a fusible powder such as a glass frit or enamel which will bond to the proppant pellet, electroplating using electrostatic techniques well known to those of ordinary skill in the art to transfer a coating material such as a less chemically reactive metallic layer to the proppant, plasma spraying, sputtering, fluidizing the proppant in a fluidized bed such as according to techniques described in U.S. Pat. No. 4,440,866, the entire disclosure of which is incorporated herein by reference, and powder coating. Those of ordinary skill in the art will recognize that other techniques may also be used to suitably apply a substantially uniform consistent coating to the proppant. Those of ordinary skill in the art will also recognize that the proppant may be coated with a solid coating, such as glass frit, high alumina clays or bauxites, metals, or other hydrophobic powders. Such coatings could be applied by spraying, tumbling, or other means known in the art for applying powder coatings.

One such coating according to the present invention may be generally described as a silicon containing compound. In certain embodiments of the present invention, the silicon containing compound is a siloxane based on the structural unit R₂SiO, wherein R is an alkyl group. In other certain embodiments of the present invention, the silicon containing compound is a nonvolatile linear siloxane of the composition: 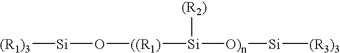
where (R₁) is an alkyl group having from one to three carbon atoms, (R₂) is either a hydrogen atom or an alkyl group having from one to three carbon atoms, (R₃) is an alkyl group having from one to four carbon atoms and n is a number between 50 and 200. In still other certain embodiments of the present invention, the suitable silicon containing compounds include polymethylhydrogen siloxane and polydimethyl siloxane.

In one process of the present invention, natural sands, manufactured proppants, and resin-coated materials are treated with a chemical treatment to reduce conductivity loss caused by fracturing fluids, to alter or modify proppant wettability, to control the relative permeability to flow of fluids which may be encountered in the reservoir, to “lubricate” the proppant to allow more efficient proppant arrangement when the fracture closes, and to reduce eventual scale buildup on proppant. According to one process of the present invention natural sands, manufactured proppants, and resin-coated materials are treated to reduce conductivity loss caused by fracturing fluids by saturating such proppant materials with hydrophobic materials as described above. According to another process of the present invention natural sands, manufactured proppants, and resin-coated materials are treated to alter or modify proppant wettability and consequently improve multiphase flow by coating the proppant materials with the silicone materials described above. Thus, various embodiments of the present invention relate to concepts and techniques to treat fracturing sand and/or proppant to:
1) reduce conductivity loss due to fracturing fluids,
2) alter or modify proppant wettability, to control the relative permeability to flow of the fluids which may be encountered in the reservoir (such as oil, water, gas, chemical treatments, and fracturing fluids),
3) “lubricate” the proppant to allow more efficient proppant arrangement when the fracture closes, effectively increasing packing efficiency and reducing the extent of proppant crushing,
4) reduce eventual scale buildup on proppant, and
5) reduce the chemical reactivity of proppant to materials encountered in the reservoir or well treatment, including but not limited to: oil, gas, water, brine, fracturing fluids, remedial acid treatments, caustic fluids commonly associated with steam or water injection, biological agents or their byproducts such as carbon dioxide and hydrogen sulfide.

Any one or more of these benefits may be achieved in a variety of ways, including but not limited to reducing chemical reactivity of the proppant by “treating” the proppant. In certain examples, treating the proppant comprises applying an inert coating, applying a coating which results in a physically smoother surface thereby reducing surface area exposed to reaction with fluids, modifying the wettability and fluid affinity of the proppant, and modifying proppant surface to reduce grain-to-grain friction. Thus, exemplary techniques for treating fracturing sand and/or proppant include but are not limited to:
1) reducing chemical reactivity of proppant by applying an inert coating,
2) applying a coating which results in a physically smoother surface thereby reducing surface area exposed to reaction with the fluids,
3) modifying the wettability and fluid affinity of the proppant, and
4) modifying proppant surface to reduce grain-to-grain friction.

Exemplary techniques for treating proppant with chemical coatings include: treating the proppant prior to the fracturing treatment; treating the proppant “on the fly” during the fracturing treatment; or, applying post-fracturing “squeeze” treatments in which an existing fracture and/or formation is contacted with chemicals. Thus, exemplary techniques for treating proppant include but are not limited to:
1) pretreating proppant prior to the fracturing treatment,
2) treating proppant “on the fly” during the fracturing treatment, and
3) post-fracturing “squeeze” treatments in which an existing fracture and/or formation can be contacted with chemicals to produce the above-mentioned benefits.

The techniques for treating proppant are not limited to proppant type, and are applicable to natural sands, manufactured proppants, and resin-coated materials. In addition, a variety of chemicals, or “coatings”, produce the desired effects.

According to various embodiments of the present invention, resin-coated proppants achieve increases in proppant pack strength by reducing point-loading by addition of a structural resin. The “lubrication” concept reduces proppant friction, allowing superior proppant redistribution during fracture closing. This redistribution allows more efficient packing of proppant, thereby increasing grain-to-grain contact and effectively increasing proppant pack strength and reducing proppant crush.

According to embodiments of the present invention, coatings affect wettability and provide significant flow benefits under multiphase flow as evidenced by the trapped gas saturation, the altered surface tension/contact angles, and the electrostatic charges on the coated proppant. In water drainage studies, it was noted that the coated proppant would remain dry and hold an 8 to 10 inch column of water above the pack until the hydrostatic head exceeded the capillary pressure of the highly altered wettability proppant. It is clear that this alteration of surface wettability has a large impact on the relative permeability under multiphase flow conditions.

Products with an “oil-wet” surface may be ideal in a gas well producing water, while products with a different wettability may give preferential flow to oil and reduce watercut. A variety of different coatings may be required to minimize gel damage, and may be customized to the specific gel chemistry. Additional coatings may be applied to lubricate proppants, or resist the deposition of scale, asphaltenes, or other mechanical plugging.

In formations frequently treated with acid as a remedial operation, proppant may be coated to minimize reactivity. Traditional untreated proppants are known to be damaged due to exposure to acid. In addition to damaging the proppant, this reactivity also consumes acid and prevents it from attacking the targeted formation fines or other material which has plugged the proppant pack. Thus, coatings may also be applied over resin-coated proppants so as to minimize the chemical interaction of such proppants with fracturing fluids.

Traditional untreated proppants are also known to be highly damaged by caustic fluids associated with high temperature water and/or steam injection. The modified proppants of the present invention will have reduced chemical reactivity and will improve performance and longevity in oil fields with steam injection.

Contrary to traditional scale inhibition treatments which focus on impregnating the reservoir and/or proppant with chemicals which are released over time and react with scale forming constituents to reduce or eliminate the amount of scale which will form in the formation, fracture, and/or wellbore tubulars, the embodiments of the present invention involve chemically or otherwise altering the surface of the proppant to reduce the tendency of scale to attach to the proppant. This proppant coating does not chemically react with the produced fluids to prohibit scale formation, but instead reduces chemical reactions between the proppant and surrounding fluids. These fluids may include, but are not limited to, oil, gas, water, brine, fracturing fluids, remedial acid treatments, caustic steam or water and biological agents.

Illustrative treated proppants, methods for their preparation and methods for their use will now be discussed with respect to the following Examples 1-7.

### EXAMPLE 1

Coated samples of a sintered bauxite proppant commercially available from CARBO Ceramics, Inc. under the tradename CARBOHSP™, a sand proppant commercially available from Badger Mining Co. under the tradename Badger Sand, and a resin-coated sand proppant commercially available from Borden Chemical Inc. under the tradename SB Prime were prepared by coating the proppant with the materials set forth in Table 1 below. Each of the samples of CARBOHSP™, Badger Sand and SB Prime had a particle size distribution that met the API designation for 20/40 proppant which specifies that the product must retain 90% between the primary 20 and 40 mesh sieves. This particle size distribution will be referred to herein as “20/40 U.S. Mesh.”

In each case, the coating was applied by mixing the proppant and the coating in a beaker for approximately 30 minutes, then drying it for approximately 15 to 18 hours in an oven. Other methods for applying a coating include, but are not limited to, other “submerging” processes similar to the process as described in this example, spraying, and mixing in mixers and mullers such as those available from Eirich Machines, Inc. Still other methods well known to those of ordinary skill in the art are also suitable for applying a coating to the proppant materials as described herein.

The coating materials were added as follows. Polymethylhydrogen siloxane was added as either a 2 or 5 weight percent emulsion of siloxane in water, polydimethyl siloxane was added as a 5 weight percent emulsion of siloxane in water and Stoddard Solvent was added without dilution. All samples were dried at 113° C. for approximately 15 to 18 hours.

The water retention data set forth in Table 1 for the CARBOHSP samples was determined by pouring 10 g. of water through a standard column of proppant (6g., about 8 cm. height) and determining the percentage of water that was retained in the column. The water retention data for the Badger Sand and the SB Prime resin-coated sand was determined by pouring 50 ml of water through a 10 g. column of the sand and determining the percentage of water that was retained in the column. The water retention data set forth in Table 1 is an average of three tests per coating. The siloxane materials showed at least a two-fold reduction in water retention compared to the uncoated proppant, whether the proppant be CARBOHSP, sand or resin-coated sand. Meanwhile, Stoddard Solvent showed some reduction, but was not as effective as the siloxanes. Also, the results for the 2% polymethyl hydrogen siloxane, applied to proppant at 75° C. demonstrates that an effective coating can be achieved while the proppant is still warm. Thus, an effective coating can be applied right after the cooler in production. Table 1 below sets forth results of the testing of such samples.

TABLE 1

| | | Bulk | | 15k | Water |
|---|---|---|---|---|---|
| | | Density | | Crush | Retention |
| Proppant | Coating | (g/cm³) | ASG | (%) | (%) |
| CARBOHSP | uncoated | 2.03 | 3.54 | 3.4 | 13.7 |
| CARBOHSP | Stoddard Solvent | 2.01 | 3.48 | 2.7 | 12.3 |
| CARBOHSP | 5% polydimethyl | 2.02 | 3.33 | 1.3 | 5.1 |
| | siloxane | | | | |
| CARBOHSP | 5% poly methyl | 1.94 | 3.09 | 1.7 | 6.0 |
| | hydrogen siloxane | | | | |
| CARBOHSP | 2% poly methyl | 1.99 | 3.30 | 2.4 | 3.7 |
| | hydrogen siloxane | | | | |
| CARBOHSP | 2% poly methyl | 2.01 | 3.11 | 3.0 | 4.4 |
| | hydrogen siloxane, | | | | |
| | applied when | | | | |
| | proppant was 75° C. | | | | |
| Badger Sand | uncoated | 1.55 | 2.63 | 51.0 | 5.2 |
| Badger Sand | 2% poly methyl | 1.55 | 1.91* | 47.2 | 2.4 |
| | hydrogen siloxane | | | | |
| SB Prime | uncoated | 1.48 | 2.55 | 18.6 | 5.8 |
| resin-coated | | | | | |
| sand | | | | | |
| SB Prime | 2% poly methyl | 1.55 | 2.18 | 13.6 | 1.5 |
| resin-coated | hydrogen siloxane | | | | |
| sand | | | | | |

*Significant number of air bubbles trapped on sample.

The term “bulk density”, as set forth in Table 1, means the weight per unit volume, including in the volume considered the void spaces between the particles.

The term “ASG” as set forth in Table 1, refers to “apparent specific gravity” which is a number without units, but is defined to be numerically equal to the weight in grams per cubic centimeter of volume, excluding void space or open porosity in determining the volume. The apparent specific gravity values given herein were determined by water displacement.

The crush values reported in Table 1 were obtained using the American Petroleum Institute (API) procedure for determining resistance to crushing. According to this procedure, a bed of about 6 mm depth of sample to be tested is placed in a hollow cylindrical cell. A piston is inserted in the cell. Thereafter, a load is applied to the sample via the piston. One minute is taken to reach maximum load which is then held for two minutes. The load is thereafter removed, the sample removed from the cell, and screened to separate crushed material. The results are reported as a percentage by weight of the original sample.

The reduction in apparent specific gravity (“ASG”) for each of the proppant samples set forth in Table 1 indicates that the coatings are waterproofing the proppant surface by preventing water from entering some of the surface porosity. Also, the CARBOHSP proppant coated with polymethylhydrogen siloxane and polydimethyl siloxane exhibited a significant reduction in crush compared to the uncoated control.

### EXAMPLE 2

Coated samples of a sintered bauxite proppant commercially available from CARBO Ceramics Inc. under the tradename CARBOHSP™ (20/40 U.S. Mesh) were prepared by coating the proppant with a product that is commercially available from SOPUS Products under the tradename “Rain-X®”. Rain-X® is a glass surface treatment material that includes polyalkyl hydrogen siloxane, ethanol and isopropanol. The coating was applied by mixing the proppant and the coating in a beaker for approximately 30 minutes, then removing the coated proppant from the beaker and drying it for approximately 15 to 18 hours in an oven.

Other coatings that may be applied to proppants include, but are not limited to, spray Teflon, liquid silicone, Black Magic™ and WD-40®. Black Magic™ is commercially available from SOPUS Products and contains polydimethyl siloxane, also known as “silicone oil” and hydrotreated light petroleum distillates. The hydrotreated light petroleum distillates can be generally described as a mixture of C₁₀-C₁₄ naphthenes, iso- and n-paraffins containing <0.1% aromatics and <0.1% hexane. The average molecular weight of the hydrotreated light petroleum distillates tends to be closer to C14, i.e. about 200. The boiling point of the hydrotreated light petroleum distillates is from 175-270° C. The density of the hydrotreated light petroleum distillates is from 0.79-0.82 g/cm³. WD-40® is commercially available from the WD 40 Company and is primarily a mixture of Stoddard solvent and heavy paraffinic solvent-dewaxed petroleum distillates. Stoddard Solvent can be generally described as a mixture of C₇-C₁₂ aliphatic and alicyclic hydrocarbons and aromatic hydrocarbons (C₇-C₁₂), usually with little or no benzene. The boiling point of Stoddard Solvent is from 130-230° C. The density of Stoddard Solvent is from 0.765-0.795 g/cm³. Heavy paraffinic solvent-dewaxed petroleum distillates can be generally described as aliphatic C₂₀-C₄₀ hydrocarbons having an average molecular weight of about 372, corresponding to about C₂₆₋₂₇. The boiling point of heavy paraffinic solvent-dewaxed petroleum distillates is about 293° C.

Other methods for applying a chemical coating include, but are not limited to, other “submerging” processes similar to the process as described in this example, spraying, and mixing in mixers and mullers such as those available from Eirich Machines, Inc. Still other methods well known to those of ordinary skill in the art are also suitable for applying a coating to the proppant materials as described herein.

As will be described further with respect to Example 4, the following properties of uncoated and coated (20/40 U.S. Mesh) samples of CARBOHSP™ were evaluated: conductivity, permeability and percent (%) retained permeability.

### EXAMPLE 3

Coated samples of a lightweight proppant commercially available from CARBO Ceramics Inc. under the tradename CARBOLITE® (20/40 U.S. Mesh) were prepared by coating the proppant with a product that is commercially available from SOPUS Products under the tradename “Rain-X®”. Rain-X® is a glass surface treatment material that includes polyalkyl hydrogen siloxane, ethanol and isopropanol. The coating was applied by mixing the proppant and the coating in a beaker for approximately 30 minutes, then removing the coated proppant from the beaker and drying it for approximately 15 to 18 hours in an oven.

Other coatings that may be applied to proppants include, but are not limited to, spray Teflon, liquid silicone, Black Magic™ which is commercially available from SOPUS Products and contains hydrotreated light petroleum distillates and polydimethyl siloxane which is also known as “silicone oil,” and WD-40® which is commercially available from the WD 40 Company and is primarily a mixture of Stoddard solvent and heavy paraffinic solvent-dewaxed petroleum distillates.

Other methods for applying a coating include, but are not limited to, other “submerging” processes similar to the process as described in this example, spraying, and mixing in mixers and mullers such as those available from Eirich Machines, Inc. Still other methods well known to those of ordinary skill in the art are also suitable for applying a coating to the proppant materials as described herein.

As will be described further with respect to Example 4, the following properties of uncoated and coated (20/40 U.S. Mesh) samples of CARBOLITE® were evaluated: conductivity, permeability and percent (%) retained permeability.

### EXAMPLE 4

In order to evaluate the effect of a coated and uncoated proppant surface on the cleanup potential of a guar and borate fracture fluid system, in terms of conductivity, permeability and percent (%) retained permeability, slurry samples of uncoated CARBOHSP™, 5% poly methyl hydrogen siloxane coated CARBOHSP™ from Example 1, 5% polydimethyl siloxane coated CARBOHSP™ from Example 1, Stoddard Solvent coated CARBOHSP™ from Example 1, Rain-X® coated CARBOHSP™ of Example 2, uncoated CARBOLITE®, and Rain-X® coated CARBOLITE® of Example 3 were prepared. Each of the proppant samples evaluated according to this Example 4 had a particle size distribution of 20/40 U.S. Mesh. The slurry for each sample comprised the proppant and a fracture fluid comprised of 40 lb/1000 gal Guar (dry powder) and 1.0 gal/1000 gal Fracsal (high temperature borate crosslinker-oil base slurry).

Conductivity is a measure of how easily fluids can flow through proppant or sand and generally the higher the conductivity, the better. Fracture fluids may be formulated to cross-link and become more viscous with time. After proppant is placed within the fracture, the fracture fluids are designed so that the gels break and are able to be flushed out. Ideally, all of the gelled fracture fluid is washed out, however, in practice, at least some of the gel sticks to the proppant. Quantitative measures of how much of the fracture fluid is flushed out are permeability and percent retained permeability compared to a control proppant that has not been exposed to fracture fluid.

The control material used for comparison purposes with respect to the CARBOHSP™ samples in this Example 4 was a 20/40 U.S. Mesh CARBOHSP™ sample subjected to 6000 psi closure stress that had never been exposed to a guar and borate fracture fluid system. The control material yielded a permeability of 410 Darcies. Thus, an ideal CARBOHSP™ proppant after exposure to the guar and borate fracture fluid system would yield a permeability of 410 Darcies and when compared to the control, a percent retained permeability of 100%.

The control material used for comparison purposes with respect to the CARBOLITE® samples in this Example 4 was a 20/40 U.S. Mesh CARBOLITE® sample subjected to 4000 psi closure stress but that had never been exposed to a guar and borate fracture fluid system. The control material yielded a permeability of 450 Darcies. Thus, an ideal CARBOLITE® proppant after exposure to the guar and borate fracture fluid system would yield a permeability of 450 Darcies and when compared to the control, a percent retained permeability of 100%.

The term “regain” as set forth below refers to how much permeability is regained by flushing out the fracture fluid.

The fracture fluid was prepared as follows: The polymer (guar) was hydrated at a pH near 7.0. Following hydration, the pH was adjusted with 10 lb/1000 gal K₂CO₃ to 10.2, and a 0.1 lb/1000 gal AP breaker was added. Finally, the 1.0 gal/1000 gal Fracsal (borate crosslinker) was added.

The slurry was then prepared by mixing about 64 grams of the selected proppant with 30 ml of the crosslinked guar/borate fracture fluid.

The slurry was top loaded between two saturated Ohio Sandstone cores to mimic actual conditions in an oil or gas well. Static leakoff, which consists of draining off excess fluid at low pressure, was conducted at a closure stress of from 100 psi to 1000 psi and a temperature of from 150° F. to 200° F. ramped over 90 minutes. After the static leakoff was completed, the test was shut-in for heating and breaking overnight (minimum 12 hrs). After overnight shut-in, flow was initiated through the pack at 0.5 ml/min to obtain the pressure drop required to initiate flow which is identified as “<dp” in the Tables of data set forth in this Example 4. Generally, the lower the pressure drop, the better as it is easier to start the cleanout. Following this, the rate was stepwise increased to 2.0 ml/min at the 1000 psi closure stress. After obtaining conductivity and widths, the closure was ramped at 100 psi/min to the target evaluation closure stress.

The CARBOHSP™ samples were evaluated at 6000 psi closure stress and 200° F. The CARBOLITE® samples were evaluated at 4000 psi closure stress and 200° F. Cleanup was evaluated at 2 ml/min with 2% KCI for 50 hours. During data acquisition, the rate was increased to 4 ml/min to obtain a system check of data linearity. The rate was returned to 2 ml/min after data acquisition.

The results for conductivity and permeability of an uncoated CARBOHSP™ sample are reported in Table 2 below:

TABLE 2

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1.5 | 1000 | 200 | 876 | 0.188 | <dp = .0054 | 56 |
| −1 | 1000 | 200 | 1797 | 0.186 | psi at | 116 |
| −0.7 | 2000 | 200 | 3793 | 0.184 | 0.5 ml/min | 247 |
| −0.5 | 4000 | 200 | 3744 | 0.182 | | 247 |
| 0 | 6000 | 200 | 3166 | 0.174 | | 218 |
| 5 | 6000 | 200 | 3009 | 0.173 | | 209 |
| 10 | 6000 | 200 | 2919 | 0.171 | | 205 |
| 20 | 6000 | 200 | 2893 | 0.171 | | 203 |
| 30 | 6000 | 200 | 2865 | 0.171 | | 201 |
| 40 | 6000 | 200 | 2836 | 0.171 | | 199 |
| 50 | 6000 | 200 | 2824 | 0.171 | | 198 |

As reported in Table 2, after 50 hours regain, the uncoated CARBOHSP™ yielded a conductivity of 2824 mD-ft and 198 Darcies permeability for a percent retained permeability of 48% pared to the control. The percent retained permeability of the uncoated CARBOHSP sample was used for comparison purposes to the coated CARBOHSP samples evaluated below.

The results for conductivity and permeability of the 5% poly methyl hydrogen siloxane coated CARBOHSP™ from Example 1 are reported in Table 3 below:

TABLE 3

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1.5 | 1000 | 200 | 1118 | 0.191 | <dp = .0050 | 70 |
| −1.4 | 1000 | 200 | 1175 | 0.191 | psi at | 74 |
| −1.2 | 2000 | 200 | 4519 | 0.188 | 0.5 ml/min | 288 |
| −0.9 | 3000 | 200 | 4763 | 0.185 | | 309 |
| −0.6 | 4000 | 200 | 4519 | 0.183 | | 296 |
| −0.3 | 5000 | 200 | 4298 | 0.181 | | 285 |
| 0 | 6000 | 200 | 4111 | 0.179 | | 276 |
| 5 | 6000 | 200 | 4061 | 0.178 | | 274 |
| 10 | 6000 | 200 | 4007 | 0.177 | | 272 |
| 20 | 6000 | 200 | 3961 | 0.176 | | 270 |
| 30 | 6000 | 200 | 3909 | 0.176 | | 267 |
| 40 | 6000 | 200 | 3893 | 0.176 | | 265 |
| 50 | 6000 | 200 | 3850 | 0.176 | | 263 |

As reported in Table 3, after 50 hours regain, the polymethyl hydrogen siloxane coated CARBOHSP yielded a conductivity of 3850 mD-ft and 263 Darcies permeability for a percent retained permeability of 64% compared to the control. Thus, the percent retained permeability of the polymethyl hydrogen siloxane coated CARBOHSP proppant of Example 1 was 16% greater than the uncoated CARBOHSP proppant.

The results for conductivity and permeability of the 5% polydimethyl siloxane coated CARBOHSP™ from Example 1 are reported in Table 4 below:

TABLE 4

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1.5 | 1000 | 200 | 402 | 0.191 | <dp = .0107 | 25 |
| −1.4 | 1000 | 200 | 2917 | 0.191 | psi at | 183 |
| −1.2 | 2000 | 200 | 4943 | 0.190 | 0.5 ml/min | 312 |
| −0.9 | 3000 | 200 | 5084 | 0.188 | | 325 |
| −0.6 | 4000 | 200 | 5234 | 0.185 | | 340 |
| −0.3 | 5000 | 200 | 4809 | 0.181 | | 319 |
| 0 | 6000 | 200 | 4533 | 0.180 | | 302 |
| 5 | 6000 | 200 | 4331 | 0.179 | | 290 |
| 10 | 6000 | 200 | 4402 | 0.178 | | 297 |
| 20 | 6000 | 200 | 4263 | 0.178 | | 287 |
| 30 | 6000 | 200 | 4183 | 0.177 | | 284 |
| 40 | 6000 | 200 | 4142 | 0.177 | | 281 |
| 50 | 6000 | 200 | 4121 | 0.177 | | 279 |

As reported in Table 4, after 50 hours regain, the polydimethyl siloxane coated CARBOHSP yielded a conductivity of 4121 mD-ft and 279 Darcies permeability for a percent retained permeability of 68% compared to the control. Thus, the percent retained permeability of the polydimethyl siloxane coated CARBOHSP proppant of Example 1 was 20% greater than the uncoated CARBOHSP proppant.

The results for conductivity and permeability of the Stoddard Solvent coated CARBOHSP™ from Example 1 are reported in Table 5 below:

TABLE 5

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1.5 | 1000 | 200 | 147 | 0.194 | <dp = .0304 | 9 |
| −1.4 | 1000 | 200 | 2928 | 0.194 | psi at | 181 |
| −1.2 | 2000 | 200 | 4298 | 0.193 | 0.5 ml/min | 267 |
| −0.9 | 3000 | 200 | 4094 | 0.188 | | 261 |
| −0.6 | 4000 | 200 | 3907 | 0.186 | | 252 |
| −0.3 | 5000 | 200 | 3582 | 0.183 | | 235 |
| 0 | 6000 | 200 | 3247 | 0.181 | | 215 |
| 5 | 6000 | 200 | 3514 | 0.178 | | 237 |
| 10 | 6000 | 200 | 3482 | 0.177 | | 236 |
| 20 | 6000 | 200 | 3447 | 0.176 | | 235 |
| 30 | 6000 | 200 | 3438 | 0.176 | | 234 |
| 40 | 6000 | 200 | 3426 | 0.176 | | 234 |
| 50 | 6000 | 200 | 3418 | 0.176 | | 233 |

As reported in Table 5, after 50 hours regain, the Stoddard solvent coated CARBOHSP yielded a conductivity of 3415 mD-ft and 233 Darcies permeability for a percent retained permeability of 57% compared to the control. Thus, the percent retained permeability of the Stoddard solvent coated CARBOHSP proppant of Example 1 was 9% greater than the uncoated CARBOHSP proppant.

The results for conductivity and permeability of the Rain-X® coated CARBOHSP™ of Example 2 are reported in Table 6 below:

TABLE 6

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1.5 | 1000 | 200 | 860 | 0.188 | <dp = .0054 | 55 |
| −1 | 1000 | 200 | 3947 | 0.186 | psi at | 255 |
| −0.7 | 2000 | 200 | 4402 | 0.184 | 0.5 ml/min | 287 |
| −0.5 | 4000 | 200 | 4235 | 0.182 | | 279 |
| 0 | 6000 | 200 | 3375 | 0.174 | | 233 |
| 5 | 6000 | 200 | 3574 | 0.173 | | 248 |
| 10 | 6000 | 200 | 3652 | 0.171 | | 256 |
| 20 | 6000 | 200 | 3866 | 0.171 | | 271 |
| 30 | 6000 | 200 | 3898 | 0.171 | | 274 |
| 40 | 6000 | 200 | 3917 | 0.171 | | 275 |
| 50 | 6000 | 200 | 3902 | 0.171 | | 274 |

As reported in Table 6, after 50 hours regain, the Rain-X® coated CARBOHSP yielded conductivity of 3902 mD-ft and 274 Darcies permeability for a percent retained permability of 67% compared to the control. Thus, the percent retained permeability of the Rain-X® coated CARBOHSP proppant of Example 2 was 19% greater than the uncoated CARBOHSP proppant.

The results for conductivity and permeability of the uncoated CARBOLITE® are reported in Table 7 below:

TABLE 7

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1 | 1000 | 200 | 1585 | 0.230 | <dp = .0032 | 83 |
| −0.7 | 1000 | 200 | 3707 | 0.230 | psi at | 193 |
| −0.5 | 2000 | 200 | 5512 | 0.227 | 0.5 ml/min | 291 |
| 0 | 4000 | 200 | 4050 | 0.222 | | 219 |
| 5 | 4000 | 200 | 4249 | 0.221 | | 231 |
| 10 | 4000 | 200 | 4201 | 0.220 | | 229 |
| 20 | 4000 | 200 | 4160 | 0.220 | | 227 |
| 30 | 4000 | 200 | 4138 | 0.220 | | 226 |
| 40 | 4000 | 200 | 4120 | 0.220 | | 225 |
| 50 | 4000 | 200 | 4112 | 0.220 | | 224 |

As reported in Table 7, after 50 hours regain, the uncoated CARBOLITE™ yielded a conductivity of 4112 md-ft and 224 Darcies permeability for a percent retained permeability of 50% compared to the control.

The results for conductivity and permeability of the Rain-X® coated CARBOLITE® of Example 3 are reported in Table 8.

TABLE 8

| Hrs at | | | | | | |
|---|---|---|---|---|---|---|
| Closure & | Closure | Temp | Conductivity | | | Permeability |
| Temperature | (psi) | Deg F. | (mD-ft) | Width (in) | | (Darcies) |
| −15 | 1000 | 150-200 | Leakoff while heating and breaking | | | |
| −1 | 1000 | 200 | 990 | 0.230 | <dp = .0046 | 52 |
| −0.7 | 1000 | 200 | 1979 | 0.230 | psi at | 103 |
| −0.5 | 2000 | 200 | 4538 | 0.227 | 0.5 ml/min | 240 |
| 0 | 4000 | 200 | 3945 | 0.222 | | 213 |
| 5 | 4000 | 200 | 4835 | 0.221 | | 263 |
| 10 | 4000 | 200 | 4736 | 0.220 | | 258 |
| 20 | 4000 | 200 | 4644 | 0.220 | | 253 |
| 30 | 4000 | 200 | 4511 | 0.220 | | 246 |
| 40 | 4000 | 200 | 4536 | 0.220 | | 247 |
| 50 | 4000 | 200 | 4556 | 0.220 | | 249 |

As reported in Table 8, after 50 hours regain, the Rain-X® coated CARBOLITE® yielded a conductivity of 4556 mD-ft and 249 Darcies permeability for a percent retained permeability of 55% compared to the control. Thus, the percent retained permeability of the Rain-X® coated CARBOLITE® proppant of Example 3 was 5% greater than the uncoated CARBOLITE® proppant.

Based on the foregoing results, it may be concluded that all coated proppant samples showed improved conductivity and retained permeability when compared to uncoated proppant. In addition, the polymethylhydrogen siloxane and polydimethyl siloxane coated CARBOHSP proppant samples had conductivities of 3850 and 4121mD-ft, 64% and 68% retained permeability, respectively which compared quite favorably to the Rain-X® coated CARBOHSP sample which had a conductivity of 3902 mD-ft and 67% retained permeability.

### EXAMPLE 5

Additional results of testing performed on coated and uncoated samples of CARBOHSP™ proppant are shown in Table 9.

TABLE 9

| | 20/40 HSP | 20/40 HSP with Rain-X ® |
|---|---|---|
| ASG | 3.56 | 3.26 |
| Bulk Density (g/cm³) | 2.00 | 2.01 |
| Crush @ 15 kpsi (%) | 3.80 | 3.66 |
| Sizing | | |
| 16 | 0.0 | 0.0 |
| 20 | 5.2 | 5.2 |
| 25 | 43.5 | 43.5 |
| 30 | 45.1 | 45.1 |
| 35 | 6.0 | 6.0 |
| 40 | 0.2 | 0.2 |
| 50 | 0.0 | 0.0 |
| pan | 0.0 | 0.0 |

Conductivity (d-ft) @ closure stress (kspi) @ 2 lbs/sqft

| | | |
|---|---|---|
| 2 | 8.9 | 9.1 |
| 4 | 7.9 | 8.2 |
| 6 | 7.1 | 7.5 |
| 8 | 6.4 | 6.7 |
| 10 | 5.6 | 5.8 |
| 12 | 4.8 | 5.0 |

The coating of the CARBOHSP® proppant with Rain-X® was performed as described above with respect to Example 2. The additional results indicate that the coated proppant exhibited an improved crush value over uncoated proppant, which may be due to improved “lubrication” of the coated proppant. The additional results also indicate that the coated proppant had a lower density than the uncoated proppant, which may be due to the trapping of air bubbles around the proppant by the coating. The conductivity of the coated proppant was also improved over that of the uncoated proppant.

### EXAMPLE 6

Additional testing was conducted with “wet” proppant having freshly applied coatings of Rain-X®, silicone spray, WD-40®, Black Magic and other materials to test the feasibility of the “on-the-fly” coating application. These tests were repeated with separate samples after the coating had dried to simulate an application process where the material is coated before delivery to the wellsite. Both techniques demonstrated potential benefits in reducing gel damage and modifying surface wettability.

The time for a known volume of water to pass through a proppant pack was recorded, both for control groups (untreated conventional proppant) and proppants treated with a variety of coatings. In some tests, proppants remained wet with the coatings, and in some tests, the coatings were pre-applied and allowed to entirely dry before loading the test apparatus. The test apparatus used to benchmark the effectiveness of various coatings and application techniques both for wettability and gel release included a cylindrical tube with a valve at one end. The tube was first packed with 17 ml. of proppant. The proppant was either treated or untreated for the control group. A known volume of a rinse fluid, typically water in the amount of 67 ml., was then added to the tube. The valve was opened and the time elapsed to drain the known volume of water through the proppant in the tube was recorded to determine apparent permeability. In some tests, the proppants were mixed with various fracturing fluids to estimate the gel adhesion to the coated and uncoated proppants.

Table 10 shows the results of initial testing with four different coatings applied immediately before mixing with fracture gel.

TABLE 10
Gel Cleanup times with freshly applied coatings
before mixing with gel slurry

| | | | | | Dry spray |
|---|---|---|---|---|---|
| Trial | Uncoated | | | | “Gunk” |
| Number | proppant | Black Magic | WD40 | Silicone | Silicone |
| 1 | 26.8 | 43.1 | 32.9 | 42 | 24.9 |
| 2 | 13.9 | 15.4 | 14.4 | 13.8 | 13 |
| 3 | 11.7 | 14.2 | 10.1 | 15.3 | 10.4 |
| 4 | 12.3 | 13.2 | 11.7 | 13.7 | 10 |
| 5 | 12.6 | 12.5 | 11.6 | 13.7 | 10.9 |
| 6 | 11.9 | | 13.2 | | 11 |
| 7 | 11.9 | | 13.1 | | |
| 8 | 11.9 | | 12.2 | | |
| 9 | 12.7 | | 12.6 | | |
| 10 | 12.2 | | 12.9 | | |
| | 12.7 | | | | |

One product was a spray-applied silicone, which dried almost immediately upon application, while the other “soak applied” coatings were noticeably moist. The spray-applied product appeared to immediately reduce the time for water to pass through the proppant pack, and provided sustained benefit in all subsequent flushes with fresh water. Also, the relatively “wet” coatings significantly delayed the infiltration of water into the pack, delaying cleanup, but potentially reducing “viscous fingering” which may be a significant benefit in some applications.

Table 11 shows the results of further experimentation with “dry” applications of Rain-X®.

TABLE 11
Gel Cleanup times with freshly applied coatings before mixing
with gel slurry

| Trial | Uncoated | RainX ® | RainX ® | Uncoated |
|---|---|---|---|---|
| Number | proppant, no gel | with gel | no gel | proppant with gel |
| 1 | 11.1 | 23.3 | 10.6 | 35 |
| 2 | 11 | 9.8 | 12.7 | 15.5 |
| 3 | 10.8 | 10.3 | 13.6 | 15.2 |
| 4 | 11 | 10.4 | 15.8 | 15.3 |
| 5 | 11.2 | 11 | 14.1 | 16.4 |
| 6 | | 11.2 | 16 | 16.9 |
| 7 | | 11.9 | 15.2 | 16.1 |
| 8 | | 12.3 | 16 | 15.4 |
| 9 | | 11.8 | | 14.9 |
| 10 | | 12.6 | | |
| 11 | | 12.6 | | |
| 12 | | 12.8 | | |
| 13 | | 13.2 | | |
| 14 | | 13.1 | | |
| 15 | | 13.2 | | |
| 16 | | 12.8 | | |
| 17 | | 12.9 | | |
| 18 | | 13.5 | | |

Two trends were noted from the results shown in Table 11. First, in both gel-contaminated and uncontaminated packs, the Rain-X® treated proppant initially allowed reduced flowtimes. Secondly, both samples treated with Rain-X® showed significantly increasing flowtimes to water with subsequent flushes. It was visually observed that the Rain-X® coated proppant trapped air bubbles that accumulated over time. It was clear that the proppant was hydrophobic. On several attempts, it was noted that the applied column of water could not infiltrate the dry pack to displace the air until after flow initiated. Further experimentation demonstrated that the pack could support an 8 to 10 inch column of water without any measurable infiltration by the water phase. In the presence of a multiphase system such as a gas well, this proppant would be expected to preferentially produce natural gas, while hindering the flow of water which would provide a tremendous economic benefit. The results shown in Table 11 clearly demonstrate the affinity of the coated proppant to be gas or oil-wet rather than water-wet. Additionally, it was noted that the Rain-X® precoated sample showed dramatically better gel cleanup than the uncoated proppant sample. In addition, the intentional alteration of the wettability of a proppant will significantly change the fluid flow characteristics within the pore structure of the proppant. Since formation fines are typically transported only by the water phase (the fines are water-wet), such coated proppants may be significantly less damaged by migrating fines than conventional non-treated proppants.

### EXAMPLE 7

According to this Example, a multiphase flow test was conducted. The multiphase flow test was conducted with respect to uncoated and polydimethyl siloxane coated CARBOHSP® and a slurry of the proppant was top loaded between two saturated Ohio Sandstone cores. In this Example, the proppant samples were evaluated at 4000 psi closure stress and 150° F. In this test, saturated gas was flowed through the cells at a constant rate (26 l/min) while increasing rates of water were simultaneously pumped through. The differential pressure was measured as the liquid flow was increased; and it was desired that the differential pressure or “dP” be as low as possible. The results from the multiphase flow test are shown in Table 12.

TABLE 12

| | |
|---|---|
| Liquid Flow | Differential Pressure (bar) |

| Rate | | Polydimethyl |
|---|---|---|
| (g/min) | Uncoated | Siloxane |
| 0 | 0.061 | 0.039 |
| 46.1 | 0.143 | 0.120 |
| 63.7 | 0.233 | 0.176 |
| 99.0 | 0.401 | 0.296 |
| 152.3 | 0.479 | 0.437 |
| 0 | 0.079 | 0.055 |

As set forth in Table 12, the polydimethyl siloxane coating showed improved (lower) pressure differential at all liquid flow rates compared to the uncoated control. Also, the beta factor for the polydimethyl siloxane sample was improved: 0.205 atm·s²/kg compared to 0.262 atm·s²/kg for the uncoated control. The multiphase flow test results in terms of a lower beta and improved multiphase flow for the polydimethyl siloxane coated CARBOHSP™ compared to the control indicated that the polydimethyl siloxane coating created a much smoother surface and covered some of the surface porosity of the CARBOHSP™. It was confirmed by scanning electron microscopy (“SEM”) at a power of 500×that the polydimethyl siloxane coating had indeed created a much smoother surface and appeared to have covered substantially all of the surface porosity of the CARBOHSP™.

The chemically coated and/or treated particles of the present invention are useful as a propping agent in methods of fracturing subterranean formations to increase the permeability thereof.

When used as a propping agent, the particles of the present invention may be handled in the same manner as other propping agents. The particles may be delivered to the well site in bags or in bulk form along with the other materials used in fracturing treatment. Conventional equipment and techniques may be used to place the particles as a propping agent.

A viscous fluid, frequently referred to as a “pad”, is injected into the well at a rate and pressure to initiate and propagate a fracture in the subterranean formation. The fracturing fluid may be an oil base, water base, acid, emulsion, foam, or any other fluid. Injection of the fracturing fluid is continued until a fracture of sufficient geometry is obtained to permit placement of the propping pellets. Thereafter, particles as hereinbefore described are placed in the fracture by injecting into the fracture a fluid or “slurry” into which the particles have previously been introduced and suspended. Following placement of the particles, the well is shut-in for a time sufficient to permit the pressure in the fracture to bleed off into the formation. This causes the fracture to close and apply pressure on the propping particles which resist further closure of the fracture. The resulting proppant distribution is usually, but not necessarily, a multi-layer pack.

The foregoing description and embodiments are intended to illustrate the invention without limiting it thereby. It will be understood that various modifications can be made in the invention without departing from the spirit or scope thereof.

1. A gas and oil well proppant comprising:
a plurality of essentially spherical particles, wherein the particles are coated with a hydrophobic material.

2. The proppant of claim 1, wherein the hydrophobic material comprises one or more hydrophobic materials selected from the group consisting of silicones, siloxanes, polytetrafluoroethylene, plant oils, hydrocarbons, copolymerized polyvinylidene chloride, glass frit and enamel.

3. The proppant of claim 1, wherein the proppant particles are coated with the hydrophobic material by one or more of spraying, dipping or soaking the proppant particles in a liquid solution of the hydrophobic material, applying a sheet of film to the proppant particles, fusing material to the proppant particles, electroplating, plasma spraying, sputtering, fluidizing and powder coating.

4. The proppant of claim 2, wherein the hydrophobic material comprises a siloxane based on the structural unit R₂SiO, wherein R is an alkyl group.

5. The proppant of claim 2, wherein a hydrophobic material comprises a nonvolatile linear siloxane of the composition: 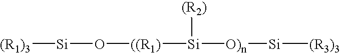
where (R₁) is an alkyl group having from one to three carbon atoms, (R₂) is hydrogen or an alkyl group having from one to three carbon atoms, (R₃) is an alkyl group having from one to four carbon atoms and n is a number between 50 and 200.

6. The proppant of claim 2, wherein the hydrophobic material is selected from the group consisting of polymethylhydrogen siloxane and polydimethyl siloxane.

7. The proppant of claim 2, wherein the plant oils comprise at least one member selected from the group consisting of linseed oil, soybean oil, corn oil, cottonseed oil, vegetable oil and canola oil.

8. The proppant of claim 2, wherein the hydrocarbons comprise at least one member selected from the group consisting of kerosene, diesel, crude oil, petroleum distillates, aliphatic solvents, solvent naphtha and paraffin.

9. A method of fracturing a subterranean formation, comprising:
injecting a hydraulic fluid into a subterranean formation at a rate and pressure sufficient to open a fracture therein; and
injecting into the fracture a fluid containing a plurality of essentially spherical particles, wherein at least some of the particles are modified to alter the surface characteristics thereof, wherein the particles are modified by coating the particles with a hydrophobic material.

10. The method of claim 9, wherein the hydrophobic material comprises one or more hydrophobic materials selected from the group consisting of silicones, siloxanes, polytetrafluoroethylene, plant oils, hydrocarbons, copolymerized polyvinylidene chloride, glass frit and enamel.

11. The method of claim 9, wherein the proppant particles are coated with the hydrophobic material by one or more of spraying, dipping or soaking the proppant particles in a liquid solution of the hydrophobic material, applying a sheet of film to the proppant particles, fusing material to the proppant particles, electroplating, plasma spraying, sputtering, fluidizing and powder coating.

12. The method of claim 9, wherein the modification of the particles alters at least one of the chemical reactivity of the particles, the surface topography of the particles, the wettability of the particles and the lubricity of the particles.

13. The method of claim 10, wherein the particles are coated with a silicone prior to injection into the fracture.

14. The method of claim 10, wherein the particles are coated with a silicone during injection into the fracture.

15. The method of claim 10, wherein the hydrophobic material comprises a siloxane based on the structural unit R₂SiO, wherein R is an alkyl group.

16. The method of claim 10, wherein the hydrophobic material comprises a nonvolatile linear siloxane of the composition: 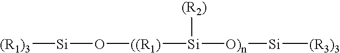
where (R₁) is an alkyl group having from one to three carbon atoms, (R₂) is hydrogen or an alkyl group having from one to three carbon atoms, (R₃) is an alkyl group having from one to four carbon atoms and n is a number between 50 and 200.

17. The method of claim 10, wherein the hydrophobic material is selected from the group consisting of polymethylhydrogen siloxane and polydimethyl siloxane.

18. The method of claim 10, wherein the plant oils comprise at least one member selected from the group consisting of linseed oil, soybean oil, corn oil, cottonseed oil, vegetable oil and canola oil.

19. The method of claim 10, wherein the hydrocarbons comprise at least one member selected from the group consisting of kerosene, diesel, crude oil, petroleum distillates, aliphatic solvents, solvent naphtha and paraffin.

20. A method of modifying the surface properties of hydraulic fracturing proppant particles, comprising:
coating the particles with a hydrophobic material.

21. The method of claim 20, wherein the hydrophobic material comprises one or more hydrophobic materials selected from the group consisting of silicones, siloxanes, polytetrafluoroethylene, plant oils, hydrocarbons, copolymerized polyvinylidene chloride, glass frit and enamel.

22. The method of claim 20, wherein the proppant particles are coated with the hydrophobic material by one or more of spraying, dipping or soaking the proppant particles in a liquid solution of the hydrophobic material, applying a sheet of film to the proppant particles, fusing material to the proppant particles, electroplating, plasma spraying, sputtering, fluidizing and powder coating.

23. The method of claim 20, wherein the modification of the particles alters at least one of the chemical reactivity of the particles, the surface topography of the particles, the wettability of the particles and the lubricity of the particles.

24. The method of claim 20, wherein the hydrophobic material comprises a siloxane based on the structural unit R₂SiO, wherein R is an alkyl group.

25. The method of claim 20, wherein the hydrophobic material comprises a nonvolatile linear siloxane of the composition: 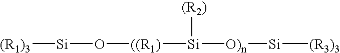
where (R₁) is an alkyl group having from one to three carbon atoms, (R₂) is hydrogen or an alkyl group having from one to three carbon atoms, (R₃) is an alkyl group having from one to four carbon atoms and n is a number between 50 and 200.

26. The method of claim 20, wherein the hydrophobic material is selected from the group consisting of polymethylhydrogen siloxane and polydimethyl siloxane.

27. The method of claim 20, wherein the plant oils comprise at least one member selected from the group consisting of linseed oil, soybean oil, corn oil, cottonseed oil, vegetable oil and canola oil.

28. The method of claim 20, wherein the hydrocarbons comprise at least one member selected from the group consisting of kerosene, diesel, crude oil, petroleum distillates, aliphatic solvents, solvent naphtha and paraffin.
